(19) United States
(12) Patent Application Publication
(10) Pub. No.: US 2025/0331667 A1
(43) Pub. Date: Oct. 30, 2025

(54) CARPET

(71) Applicant: ZHEJIANG LIZHUO CARPET CO., LTD, JINHUA (CN)

(72) Inventor: ZHENJIANG MAO, JINHUA (CN)

(21) Appl. No.: 18/648,407

(22) Filed: Apr. 28, 2024

(51) Int. Cl. A47G 27/02

(52) U.S. Cl. CPC A47G 27/025; A47G 27/0281

(57) ABSTRACT

The present utility model relates to a carpet, which comprises a carpet body, wherein the carpet body comprises a carpet top layer at the top and a carpet bottom layer at the bottom. A detachable connection is adopted between the top layer and the bottom layer. A textured surface layer is arranged on the lower surface of the carpet top layer, the carpet bottom layer is composed of a plurality of linen blocks; on the upper surface of the linen blocks is the rough surface layer, a granular rubber layer is arranged on the rough surface layer, and on the lower surface of the linen blocks is a non-slip rubber layer. For ease of cleaning, the carpet top layer can be directly removed from the lien blocks for washing when necessary, without cleaning the linen blocks. The structure with a plurality of linen blocks at the bottom facilitates transportation.

### TECHNICAL FIELD

The present utility model relates to a carpet.

### BACKGROUND ART

Carpets are decorative household items laid on the floor and playing a role in keeping warm, reducing noise and beautifying the indoor environment. Carpets are usually made of fiber materials, such as wool, silk, nylon or polyester, etc. A carpet suitable for the style and use of the room can add comfort to the room and improve the overall decorative effect.

Most of the existing carpets are 2 cm thick whole carpets, which are comfortable, but very difficult to transport and wash.

### CONTENT OF THE UTILITY MODEL

### (I) Technical Problems Solved

To address the deficiencies of the prior art, this utility model provides a carpet, which is convenient for transportation and washing.

### (II) Technical Proposal

To realize the above purposes, this utility model provides the following technical proposal: a carpet comprises a carpet body, wherein the carpet body comprises a carpet top layer at the top and a carpet bottom layer at the bottom, a detachable connection is adopted between the carpet top layer and the carpet bottom layer, a textured surface layer is arranged on the lower surface of the carpet top layer, the carpet bottom layer is composed of a plurality of linen blocks, a rough surface layer is arranged on the upper surface of the linen blocks, a granular rubber layer is arranged on the rough surface layer, a non-slip rubber layer is arranged on the lower surface of the linen blocks, and a close detachable connection is formed between the textured surface layer underneath the carpet top layer and the rough surface layer at the upper end face of the linen blocks.

Further, the utility model has the following improvement: each of the linen blocks has the same area.

Further, the utility model has the following improvement: the carpet top layer is 1 cm thick, and the linen blocks are 1 cm thick.

Further, the utility model has the following improvement: the carpet top layer comprises a decorative surface layer located at the top and a detachable connection layer connected at the bottom.

Further, the utility model has the following improvement: the textured surface layer on the lower surface of the carpet top layer is a textured fabric surface layer produced by weaving process.

Further, the utility model has the following improvement: the detachable connection layer is a woven fabric layer, and the lower surface of the detachable connection layer is the textured surface layer produced by weaving process.

Further, the utility model has the following improvement: the granular rubber layer is bonded to the upper surface of the linen blocks, and the non-slip rubber layer is bonded to the lower surface of the linen blocks (2).

### (III) Beneficial Effects

Compared with the prior art, this utility model provides a carpet, which has the following beneficial effects:

The carpet top layer can be directly removed from the lien blocks for washing when necessary. This means that there is no need to wash the linen blocks, making the washing process more convenient and efficient. This feature also saves more than half of the washing cost and makes drying easier, preventing mold and bacteria growth. The carpet bottom layer at the bottom of the thick carpet is not easily contaminated in actual use due to the protection of the carpet top layer. The utility model achieves an anti-slip effect by the natural combination of linen and textured surface of the carpet, so that a detachable connection structure is formed between the two. This feature allows for washing of just the carpet top layer. Since the linen blocks do not require frequent washing, this further enhances the service life of the carpet bottom layer. Further, the carpet bottom layer is formed by splicing a plurality of linen blocks, so that the carpet bottom layer can be piled like tiles, thereby facilitating transportation and storage; when individual linen blocks are dirty or damaged, the corresponding linen blocks can be washed or replaced, making the operation convenient and cost-effective. This utility model adopts a very user-friendly design, thereby having certain economic and industrial values.

### BRIEF DESCRIPTION OF THE DRAWINGS

FIG. 1 is the structure diagram 1 of the utility model;

FIG. 2 is the structure diagram 2 of the utility model;

In the drawings: 1. Carpet top layer; 2. Linen block; 3. Rough surface layer; 4. Granular rubber layer; 5. Non-slip rubber layer; 6. Textured surface layer.

### DETAILED DESCRIPTION OF EMBODIMENTS

The technical proposal in the embodiment of the utility model is clearly and completely described below in combination with the drawings to the embodiment of the utility model. Obviously, the embodiment described is only part of the embodiments of the utility model, but not all the embodiments. Based on the embodiments of the utility model, all other embodiments obtained by those skilled in this field without exercising creative labor fall within the scope of protection of this utility model.

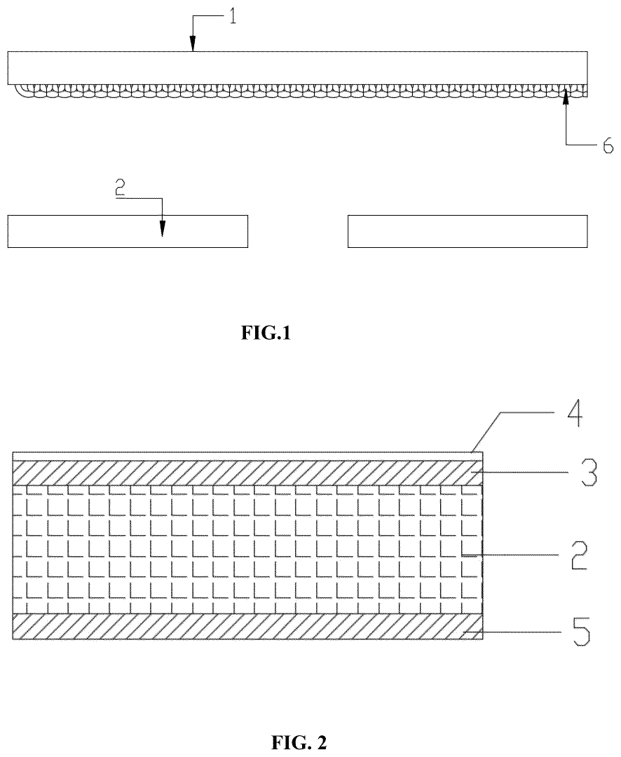

Please refer to FIG. 1 and FIG. 2. The utility model relates to a carpet, which comprises a carpet body, wherein the carpet body 1 comprises a carpet top layer at the top and a carpet bottom layer at the bottom, a detachable connection is adopted between the carpet top layer 1 and the carpet bottom layer, a textured surface layer 6 is arranged on the lower surface of the carpet top layer, the carpet bottom layer is composed of a plurality of linen blocks 2, a rough surface layer 3 is arranged on the upper surface of the linen blocks 2, a granular rubber layer 4 is arranged on the rough surface layer 3, a non-slip rubber layer 5 is arranged on the lower surface of the linen blocks 2, and a close detachable connection is formed between the textured surface layer 6 underneath the carpet top layer 1 and the rough surface layer 3 at the upper end face of the linen block.

Further, each of the linen blocks 2 has the same area.

Further, the carpet top layer 1 is 1 cm thick, and the linen blocks 2 are 1 cm thick.

Further, the carpet top layer 1 comprises a decorative surface layer located at the top and a detachable connection layer connected at the bottom.

Further, the textured surface layer 6 on the lower surface of the carpet top layer 1 is a textured fabric surface layer produced by weaving process.

Further, the detachable connection layer is a woven fabric layer, and the lower surface of the detachable connection layer is the textured surface layer 6 produced by weaving process.

Further, the granular rubber layer 4 is bonded to the upper surface of the linen blocks 2, and the non-slip rubber layer 5 is bonded to the lower surface of the linen blocks 2, facilitating the installation of the granular rubber layer 4 and the non-slip rubber layer 5.

The structure achieves the anti-slip effect by the napping and glueing processes and the natural combination of linen and textured surface of the carpet. the carpet bottom layer is formed by splicing a plurality of linen blocks 2 to facilitate transportation, and the linen blocks 2 are easily replaced when being damaged. The rough surface layer 3 on the upper end face of the linen blocks 2 can be directly formed by the napping process, etc. After the granular rubber is connected to the rough surface layer 3, the rough surface layer 3 has a rougher and harder texture, especially the linen fiber hair on the upper end face forms a shape similar to a “barb”, and further forms a close fixed connection structure with the textured fabric surface layer produced by the weaving process above, preventing horizontal sliding.

When the carpet top layer 1 is laid on the carpet bottom layer, the textured surface layer 6 is in contact with the rough surface layer 3 and the granular rubber layer 4 on the linen blocks 2, so that the carpet top layer 1 can cover and be fixed on the carpet bottom layer to prevent the carpet top layer 1 from moving on the carpet bottom layer; the textured surface layer 6 is achieved by interweaving fiber ropes, which can increase the friction between the carpet top layer 1 and the linen blocks 2, and then improve the stability of the carpet top layer 1 during use. When necessary, the carpet top layer 1 can be directly removed from the linen blocks 2 for washing. This means that there is no need to wash the linen blocks 2, making the carpet top layer 1 more convenient to handle and thus easier to wash.

When the structure is used, patterns can also be selectively printed on the linen blocks 2, which will make the linen blocks 2 look more aesthetic.

Moreover, the carpet bottom layer is located below the carpet top layer 1 in the structure, so the linen blocks 2 do not require frequent washing, which can further improve the service life of the carpet bottom layer.

Although the embodiments of this utility model have been shown and described, it is understandable for those skilled in the field that such embodiments may be changed, altered, replaced, and modified in various forms without deviation from the principle and spirit of the utility model, and that the scope of the utility model is limited by the claims and their equivalents.

1. A carpet, comprising a carpet body, characterized in that the carpet body comprises a carpet top layer (1) at the top and a carpet bottom layer at the bottom, a detachable connection is adopted between the carpet top layer (1) and the carpet bottom layer, a textured surface layer (6) is arranged on the lower surface of the carpet top layer (1), the carpet bottom layer is composed of a plurality of linen blocks (2), a rough surface layer (3) is arranged on the upper surface of the linen blocks (2), a granular rubber layer (4) is arranged on the rough surface layer (3), and a non-slip rubber layer (5) is arranged on the lower surface of the linen blocks (2).

2. The carpet according to claim 1, characterized in that each of the linen blocks (2) has the same area.

3. The carpet according to claim 2, characterized in that the carpet top layer (1) is 1 cm thick, and the linen blocks (2) are 1 cm thick.

4. The carpet according to claim 3, characterized in that the carpet top layer (1) comprises a decorative surface layer located at the top and a detachable connection layer connected at the bottom.

5. The carpet according to claim 3, characterized in that the textured surface layer (6) on the lower surface of the carpet top layer (1) is a textured fabric surface layer produced by weaving process.

6. The carpet according to claim 4, characterized in that the detachable connection layer is a woven fabric layer, and the lower surface of the detachable connection layer is the textured surface layer (6) produced by weaving process.

7. The carpet according to claim 5, characterized in that the granular rubber layer (4) is bonded to the upper surface of the linen blocks (2), and the non-slip rubber layer (5) is bonded to the lower surface of the linen blocks (2).
